(19) United States
(12) Patent Application Publication
(10) Pub. No.: US 2014/0149892 A1
(43) Pub. Date: May 29, 2014

(54) METHOD FOR BROWSING THE INTERNET USING COMMUNICATION SESSIONS

(71) Applicant: Chefif Atia Algreatly, (US)

(72) Inventor: Cherif Atia Algreatly, Palo Alto, CA (US)

(73) Assignee: Cherif Atia Algreatly, Newark, CA (US)

(21) Appl. No.: 13/686,902

(22) Filed: Nov. 27, 2012

(51) Int. Cl. G06F 3/01

(52) U.S. Cl. CPC G06F 3/01
USPC 715/760

(57) ABSTRACT

A method for browsing websites, search engine results, cloud application projects, and desktop application files using communication sessions such as blogs, forums, and chat rooms. This method enables users to create communication sessions with titles associated with a webpage, a search keyword, a cloud application, or a desktop application; display the titles once the webpage, search keyword, cloud application, or desktop application is opened on the computer display; and open a communication session by selecting its title on the computer screen.

### CROSS-REFERENCE TO RELATED APPLICATION

This application claims the benefits of U.S. Provisional Patent Applications No. 61/742,634, filed Aug. 15, 2012.

### BACKGROUND

The traditional method of browsing the internet hasn't changed for decades. For example, to browse websites, users must visit a homepage with a plurality of hypertext that leads to other webpages of the website, and these webpages lead to each other using the same or different pluralities of hypertext. Such website browsing is mainly based on trial and error, while users do not benefit from the experience of other users who are simultaneously visiting or have previously visited the website.

To use an online search engine, users must enter one or more keywords into a search text box. Results generate as website URLs which link to webpages containing information related to the search keyword(s). Such online searching is mainly based on trial and error, with the user browsing one or more websites provided by the search results without benefiting from the experience of other users who are simultaneously searching or have previously searched for the same keyword(s).

Moreover, internet browsing is mainly limited to web applications. Very limited usage of browsing for desktop applications exists, and accordingly, users of desktop applications do not collaborate with each other while they are simultaneously working on the same desktop application. This problem also applies to the cloud applications where users work separately on their computers without collaborating with other users of the same cloud application. Therefore, there is a need for a new method that changes traditional internet browsing, online searching, and desktop or cloud application usage, in order to increase users' efficiency and productivity.

### SUMMARY

In one embodiment, the present invention discloses a method for browsing a website using communication sessions. This method enables users to create a communication session associated with webpage URL; label this communication session with a title; display this title on the computer screen when opening the website or any of its webpages; and, by selecting the title from the computer screen, open the communication session and its associated webpage(s).

In another embodiment, the present invention discloses a method for searching online using communication sessions. This method enables users to create a communication session associated with a webpage URL and search keyword; label this communication session with a title; display this title on the computer screen when this search keyword is entered into a search text box; and, by selecting the title from the computer screen, open this communication session and its associated webpage(s).

In one embodiment, the present invention discloses a method for browsing a cloud application project using communication sessions. This method enables users to create a communication session associated with a cloud application project URL; label this communication session with a title; display this title on the computer screen when opening this cloud application; and, by selecting the title from the computer screen, open the communication session and the cloud application project on the computer display.

In another embodiment, the present invention discloses a method for browsing a desktop application project using communication sessions. This method enables users to create a communication session associated with a desktop application project; label this communication session with a title; display this title on the computer screen when opening this desktop application; and, by selecting the title from the computer screen, open the communication session and the desktop application project.

### BRIEF DESCRIPTION OF THE DRAWINGS

FIG. 1 illustrates a titles window of a website presented on the computer display.

FIG. 2 illustrates opening a first communication session when selecting a first title of the website's titles window.

FIG. 3 illustrates opening a second communication session when selecting a second title of the website's titles window.

FIG. 4 illustrates a form that enables the user to generate a communication session associated with a title related to the website.

FIG. 5 illustrates a titles window of a search keyword presented on the computer display.

FIG. 6 illustrates opening a first communication session when selecting a first title of the search keyword's titles window.

FIG. 7 illustrates opening a second communication session when selecting a second title of the search keyword's titles window.

FIG. 8 illustrates a form that enables the user to generate a communication session associated with a title related to the search keyword.

FIG. 9 illustrates a titles window of a cloud application presented on the computer display.

FIG. 10 illustrates opening a first communication session when selecting a first title of the cloud application's titles window.

FIG. 11 illustrates opening a second communication session when selecting a second title of the cloud application's titles window.

FIG. 12 illustrates a form that enables the user to generate a communication session associated with a title related to the cloud application.

FIG. 13 illustrates a titles window of a desktop application presented on the computer display.

FIG. 14 illustrates opening a first communication session when selecting a first title of the desktop application's titles window.

FIG. 15 illustrates opening a second communication session when selecting a second title of the desktop application's titles window.

FIG. 16 illustrates a form that enables the user to generate a communication session associated with a title related to the desktop application.

FIG. 17 illustrates a graphical user interface for the present invention that enables the user to browse various communication sessions.

### DETAILED DESCRIPTION

In one embodiment, the present invention discloses a method for browsing a website using communication sessions. This method enables users to create a communication session associated with a webpage URL; label this communication session with a title; display this title on the computer screen when opening the website or any of its webpages; and, by selecting the title from the computer screen, open the communication session and its associated webpage(s).

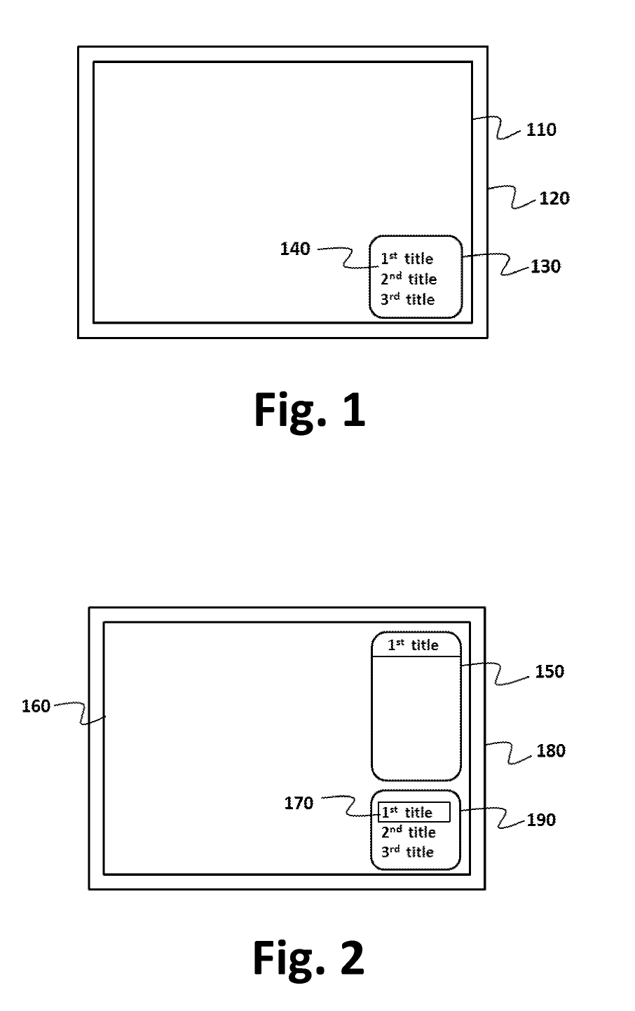

For example, FIG. 1 illustrates a website's homepage 110 opened on the computer display 120. A titles window 130 appears, presenting titles 140 of communication sessions created for this website. Each one of these communication sessions is associated with a webpage. FIG. 2 illustrates opening a communication session 150 and a webpage 160 of the website that is associated with the first title 170 by selecting the first title on the computer screen 180 from the titles windows 190. The communication session contains comments or information related to this webpage.

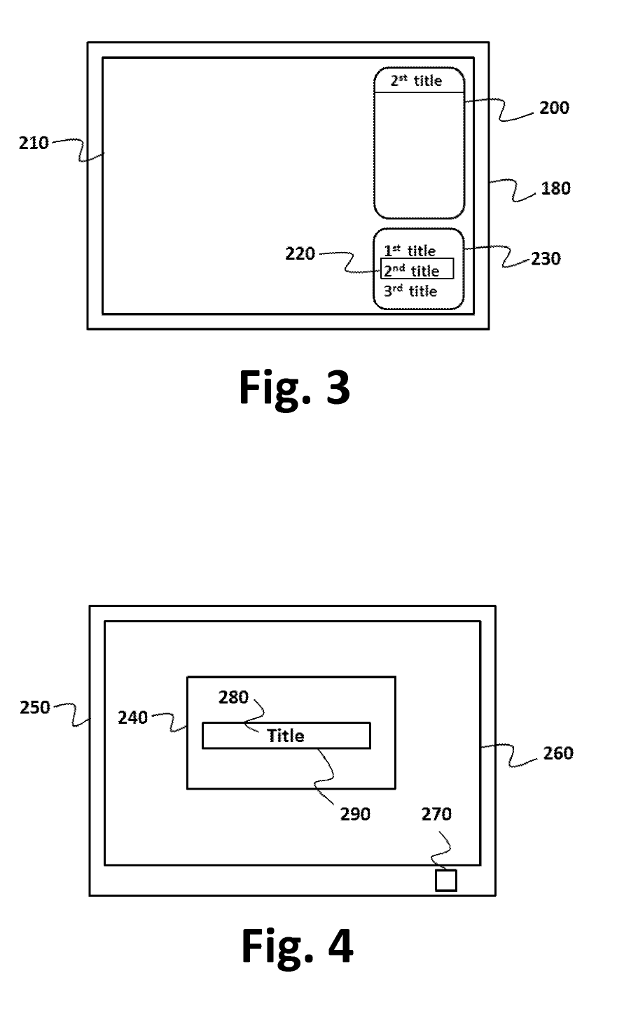

FIG. 3 illustrates opening another communication session 200 and webpage 210 of the website that is associated with the second title 220 by selecting this second title from the titles window 230 on the computer screen. Closing this website closes the titles window. Opening another website also opens another titles window with other titles related to the new or opened website.

FIG. 4 illustrates a form 240 that appears 250 when the user clicks on a small icon 270 on the bottom side of the computer screen while a webpage 260 is opened. As shown in the figure, this form enables the user to generate a communication session associated with a title 280 that the user can type into a text box 290. Once the user provides the present invention with a title, this title appears on the computer screen when any webpage of the website is opened on any computer display.

The title includes any information related to the webpage that is associated with this title. In one embodiment of the present invention, the title includes a picture that the user uploads to attract the attention of the website visitors or to convey visual information related to the webpage content. For example, if the webpage contains news or information about a car, the user can upload a picture of the car. If the webpage contains news or information about an actor, the user can upload a picture of this actor. In another embodiment of the present invention, the title contains the caption of the webpage wherein such case the user doesn't need to manually enter this caption since the present invention automatically detects this caption.

In one embodiment of the present invention, the communication session is an interactive blog that is maintained by a user who submits regular entries of commentary with other materials such as graphics or video, allowing other users to leave comments or messages. In another embodiment of the present invention, the communication session is a forum where users can hold conversations in the form of posted messages that can be archived. In one embodiment of the present invention, the communication session is a chat room including text, voice, and video conference chat.

It is important to note that the users of the present invention who browse any webpage will find communication sessions opened already on the computer display, with the titles window displaying titles of other communication sessions of other webpage branches of the same website. This method enables users to browse the website in an innovative manner by drawing from the experience of other people who have previously visited the website. However, the same webpage may have more than one communication session with different titles created by one or more user.

In another embodiment, the present invention discloses a method for searching online using communication sessions. This method enables users to create a communication session associated with a webpage URL and a search keyword; label this communication session with a title; display this title on the computer screen when this search keyword is entered into a search text box; and, by selecting the title from the computer screen, open the communication session and its associated webpage(s).

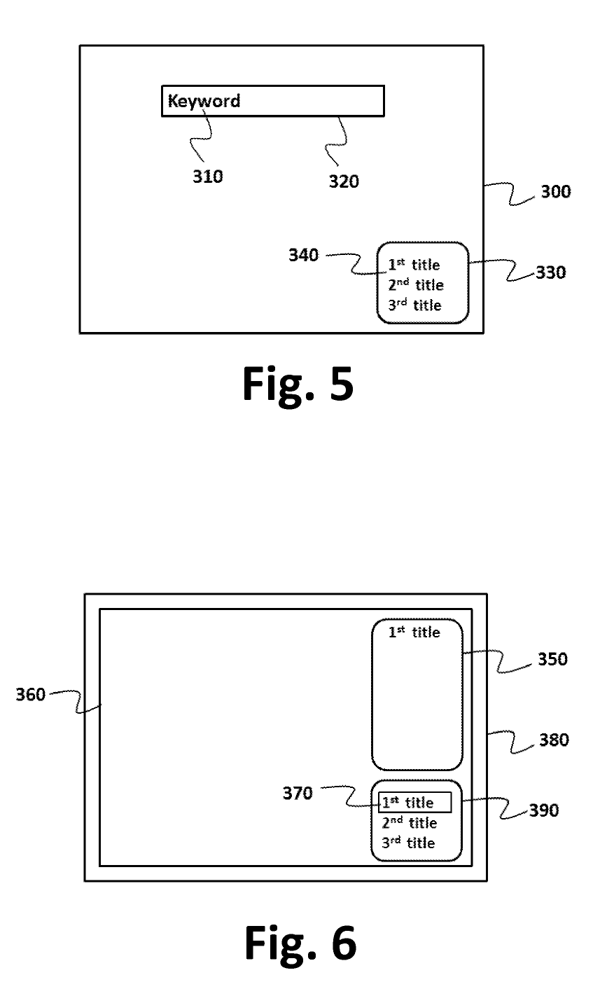

For example, FIG. 5 illustrates an online search engine 300 where users enter a keyword 310 into the search text box 320. A titles window 330 appears, presenting titles of communication sessions 340 created for this keyword. Each one of these communication sessions is associated with a webpage. FIG. 6 illustrates opening a communication session 350 and webpage 360 that are associated with the first title 370 by selecting the first title on the computer screen 380 from the titles window 390. This webpage contains information related to the keyword, and the communication session contains messages or information related to the keyword.

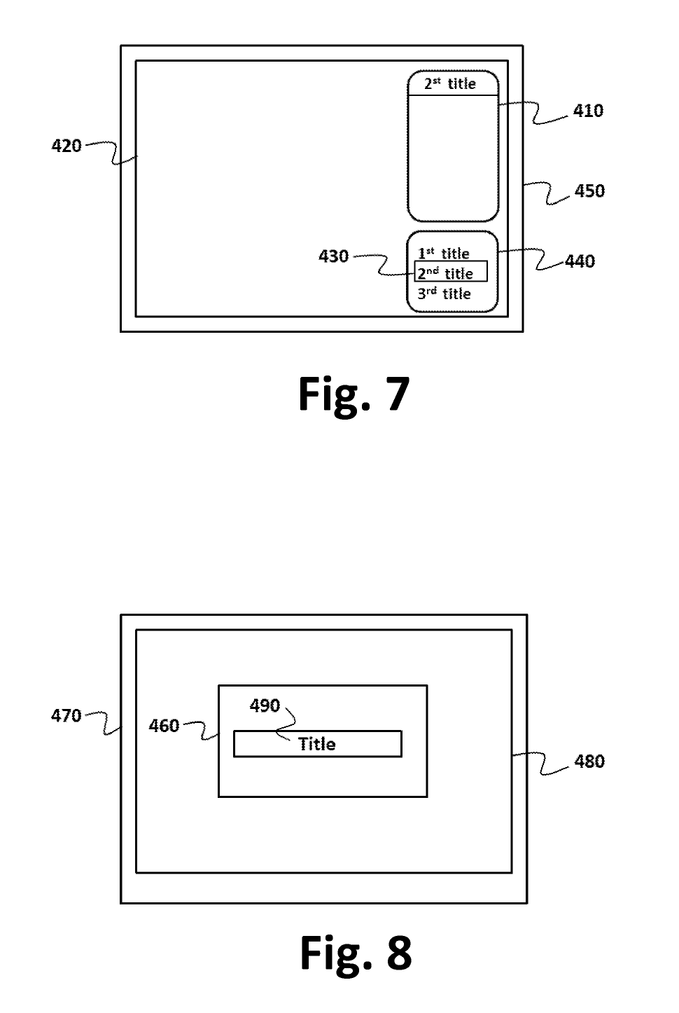

FIG. 7 illustrates opening another communication session 410 and a webpage 420 associated with a second title 430 by selecting the second title from the titles window 440. The titles window appears again on the computer screen 450, presenting the titles of the communication sessions. Entering a new search keyword into the search engine text box invokes a new titles window on the computer screen. This new title window contains titles related to the new search keyword.

FIG. 8 illustrates a form 460 that appears on the computer display 470 on top of a search result 480, selected by the user from search engine results, when searching for a keyword that has not been previously stored in the database of the present invention. As shown in the figure, this form enables the user to generate a communication session associated with a title 490, determined by the user. Once the user provides the present invention with a title, this title will appear on the computer screen when this user or another user searches for this keyword using an online search engine.

The title includes any information related to its associated webpage. In one embodiment of the present invention, the title includes a picture that the user uploads to convey visual information related to the webpage content. For example, the picture can be related to the search keyword. In another embodiment of the present invention, the title contains the caption of the webpage wherein such case the user doesn't need to manually enter this caption since the present invention automatically detects this caption.

In one embodiment of the present invention, the communication session is an interactive blog that is maintained by a user who submits regular entries of commentary with other materials such as graphics or video, allowing other users to leave comments or messages. In another embodiment of the present invention, the communication session is a forum where users can hold conversation in the form of posted messages that can be archived. In one embodiment of the present invention, the communication session is a chat room including text, voice, or video conference chat.

It is important to note that users of the present invention who browse a webpage will find communication sessions of different search keywords related to the webpage opened on the computer screen. This allows users to understand the content of the webpage based on keywords and communication sessions. Accordingly, users can join and participate with other users in such communication sessions. However, it is important to note that the same search keyword can have more than one communication session with different titles created by one or more user.

In one embodiment, the present invention discloses a method for browsing a cloud application project using communication sessions. This method enables users to create a communication session associated with a cloud application project or file; label this communication session with a title; display this title on the computer screen when opening this cloud application; and, by selecting the title from the computer screen, open the communication session and the cloud application project or file.

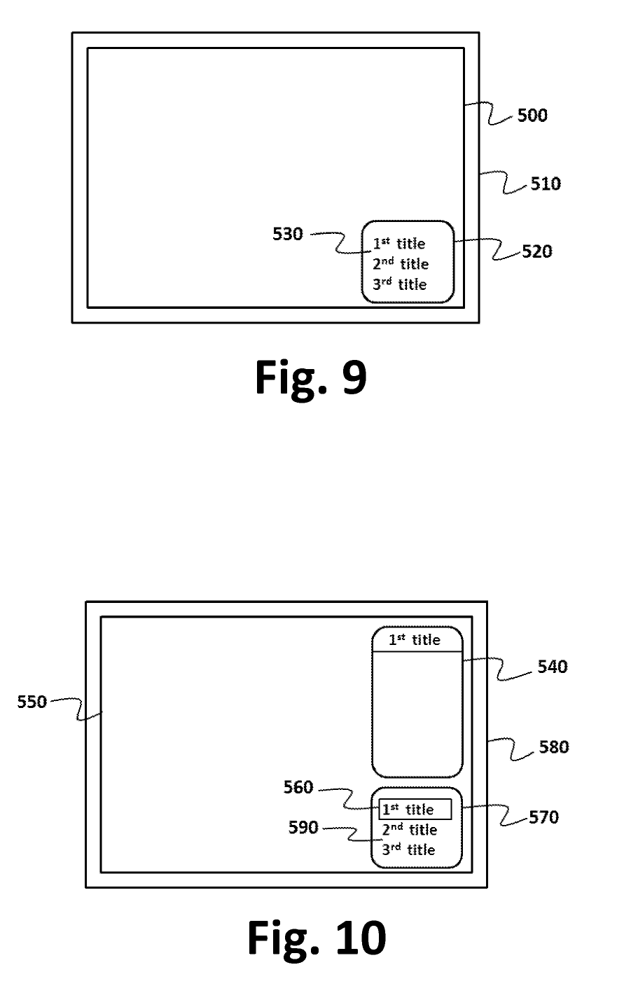

For example, FIG. 9 illustrates a cloud application 500 opened on the computer screen 510 where a titles window 520 appears with communication session titles 530 created for this cloud application, where each one of these communication sessions is associated with a project. FIG. 10 illustrates opening a communication session 540 and a cloud application project 550 associated with the first title 560 by selecting the first title of the titles windows 570 on the computer screen 580. The communication session contains comments or information related to the cloud application.

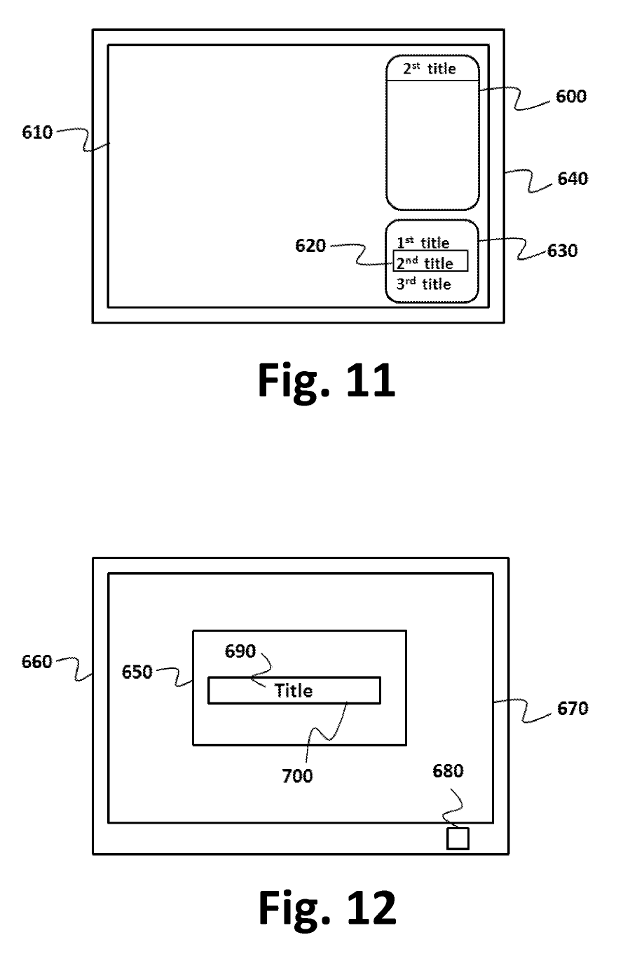

FIG. 11 illustrates opening another communication session 600 and another cloud application project 610 associated with a second title 620 by selecting the second title from the titles window 630 on the computer display 640. Closing this cloud application closes the titles window with its communication session. Opening a new cloud application opens another title window related to this new cloud application.

FIG. 12 illustrates a form 650 that appears on the computer display 660 on top of a cloud application 670 when the user clicks on the small icon 680 at the bottom side of the computer screen. As shown in the figure, this form enables the user to create a communication session associated with a title 690 that the user can type into a text box 700. Once the user creates a communication session with a title, this title simultaneously appears on the computer screen when its cloud application is opened.

In one embodiment of the present invention, the title includes information related to its associated project or cloud application. In another embodiment of the present invention, the title includes a picture that the user uploads to convey visual information related to the project or the cloud application. For example, the picture can be a screenshot of the project or the cloud application. In another embodiment of the present invention, the title includes a video or multimedia related to the project or the cloud application.

In one embodiment of the present invention, the communication session is an interactive blog that is maintained by a user who submits regular entries of commentary with other materials such as graphics or video, allowing other users to leave comments or messages. In another embodiment of the present invention, the communication session is a forum where people can hold conversation in the form of posted messages that can be archived. In one embodiment of the present invention, the communication session is a chat room including text, voice, or video conference chat.

In one embodiment, the present invention discloses a method for browsing a desktop application project or file using communication sessions. This method enables users to create a communication session associated with a desktop application project or file; label this communication session with a title; display this title on the computer screen when opening this desktop application; and, by selecting the title from the computer screen, open the communication session and the desktop application project or file.

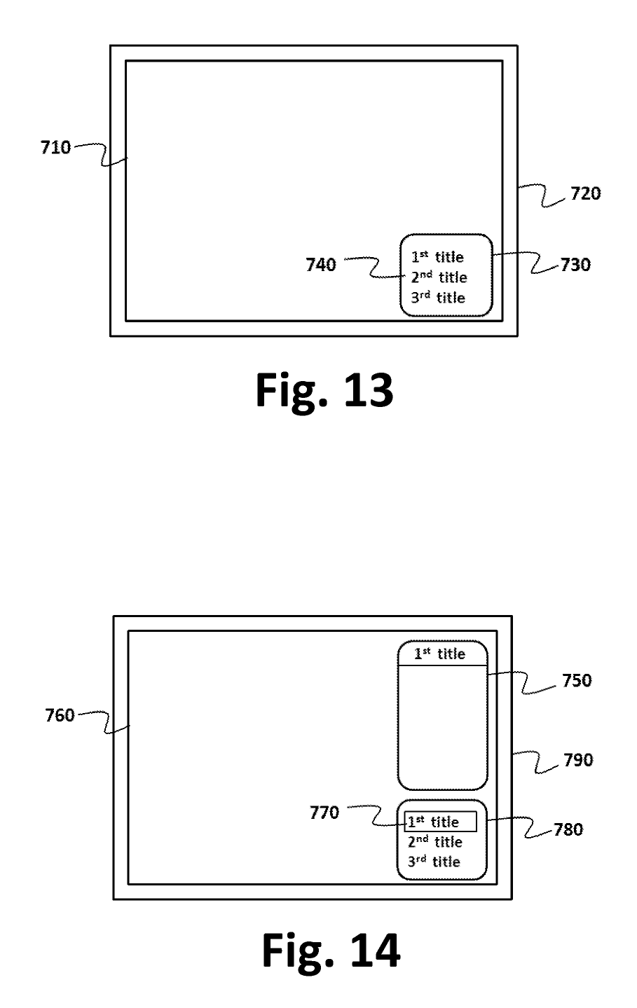

For example, FIG. 13 illustrates a desktop application 710 opened on the computer display 720. A titles window 730 appears, presenting titles of communication sessions 740 created for this desktop application. Each one of these communication sessions is associated with a file. FIG. 14 illustrates opening the communication session 750 and the file 760 that are associated with the first tile 770 by selecting this first title of the titles windows 780 on the computer screen 790.

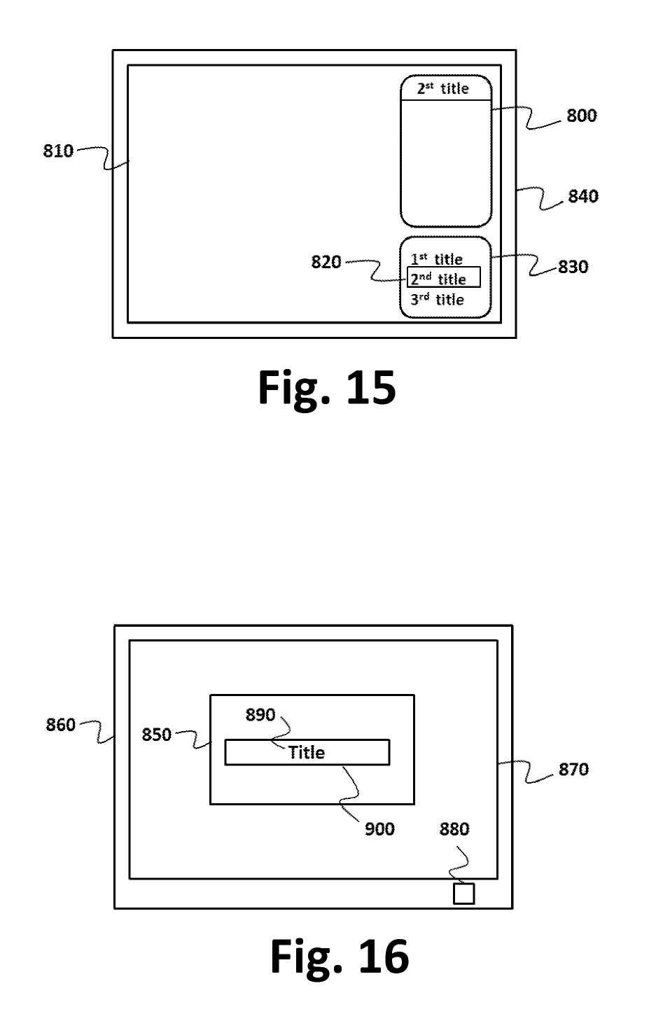

FIG. 15 illustrates opening another communication session 800 and another file 810 associated with a second title 820 by selecting the second title from the titles window 830 on the computer display 840. Closing this desktop application closes the title window on the computer. Opening a new desktop application on the computer display opens a new titles window with new titles related to this new desktop application.

FIG. 16 illustrates a form 850 that appears on the computer display 860 on top of a desktop application 870 when the user selects the icon 880 at the bottom side of the screen while a desktop application is opened. As shown in the figure, this form enables the user to create a communication session associated with a title 890 that the user can type into a text box 900. Once the user creates a communication session with a title, this title appears in the titles windows when the desktop application is opened on the computer screen.

In one embodiment of the present invention, the title includes information about the desktop application or a related file or project. In another embodiment of the present invention, the title includes a picture or a snapshot that the user uploads to convey visual information for the desktop application or a related file or project. In another embodiment of the present invention, the title includes a video or multimedia related for the desktop application or a related file or project.

In another embodiment of the present invention, the communication session is an interactive blog that is maintained by a user who submits regular entries of commentary with other materials such as graphics or video, allowing other users to leave comments or messages. In another embodiment of the present invention, the communication session is a forum where people can hold conversation in the form of posted messages that can be archived. In one embodiment of the present invention, the communication session is a chat room including text, voice, or video conference chat.

In one embodiment of the present invention, the number of online users who are simultaneously using a communication session such as a chat room is presented with each title in the titles window. This enables users to select which communication session to join. In another embodiment of the present invention, users can rate each communication session they join, and the accumulated rate of each communication session appears with its title in the titles windows. This feature is important, especially when using the present invention with search engines, because users can find out which webpage includes the most useful information related to the search keyword based on other users' experience.

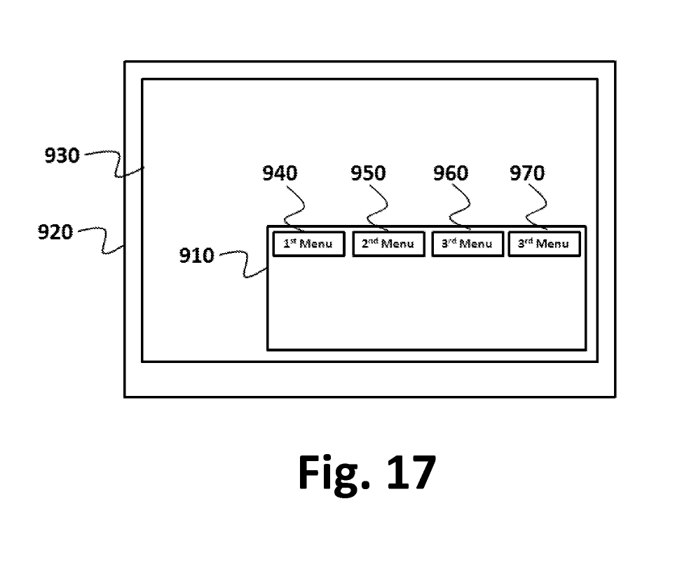

In one embodiment of the present invention, as shown in FIG. 17, a graphical user interface 910 appears as a form on the computer screen 920 when opening a website, search engine, cloud application, or desktop application 930. As shown in the figure, there are four dropdown menus 940 to 970. The first menu 940 presents the most active website communication sessions. The second menu 950 presents the most active search keyword communication sessions. The third menu 960 presents the most active cloud application communication sessions. The fourth menu 970 presents the most active desktop application communication sessions. This form, or graphical user interface, enables the user to join different communication sessions based on the number of online users who are simultaneously joining, participating, or using these communication sessions.

It is important to note that in case of opening multiple websites, cloud applications, or desktop applications on the same computer screen, the present invention displays a list of titles windows, of which the user can select to show its communication sessions. This ensures that users can join a communication session of a website, cloud application, or desktop application even if the session is not the current active application on the computer screen, and is instead minimized, or hidden under another open application.

Accordingly, in one embodiment, the present invention displays a list of titles windows associated with multiple websites, cloud applications, or desktop applications; opens the titles window that is selected from this list; and gives the option to open the titles window alone or simultaneously with its associated webpage, cloud application, or desktop application on the computer display.

Generally, the present invention's method for browsing the internet via communication sessions utilizes a plurality of client computers connected to a server computer with a database that associates each website, search keyword, cloud application, and desktop application with a unique titles window that includes a plurality of titles, each of which is associated with a different communication session.

In one embodiment of the present invention, each client computer has a unique ID that identifies which client computer creates each communication session. In another embodiment of the present invention, users have individual profiles comprised of a screen name, password, and some personal information. This profile creates a social network around each website, search keyword, cloud application, and desktop application by letting users of the present invention form different circles and online friends.

In one embodiment of the present invention, the communication session is linked to a certain part, article, paragraph, image, or video of the webpage. This is achieved by highlighting the certain part, article, paragraph, image, or video of the webpage on the computer display. It is also possible to draw an arrow that connects between the frame of the communication session and the certain part, article, paragraph, image, or video of the webpage on the computer display. The feature ensures attracting the attention of the user to the specific element of the webpage that the communication session is related to it.

1. A method for browsing a website using communication sessions wherein said method comprising of;
associating said website with a communication session correlated with a webpage, and title;
displaying said title when opening said website; and
opening said communication session and said webpage once said title is selected.

2. The method of claim 1 wherein said title includes text, webpage caption, image, or video.

3. The method of claim 1 wherein said communication session is an interactive blog, forum, or chat room.

4. The method of claim 1 wherein said communication session is linked to a certain part, article, paragraph, image, or video of said webpage by highlighting said certain part, said article, said paragraph, said image, or said video.

5. The method of claim 1 wherein said communication session is linked to a certain part, article, paragraph, image, or video of said webpage by drawing an arrow connecting between said communication session and said certain part, said article, said paragraph, said image, or said video.

6. A method for a keyword search using communication sessions wherein said method comprising of;
associating said keyword with a communication session correlated with a webpage, and title;
displaying said title when typing said keyword in a search box; and
opening said communication session and said webpage once said title is selected.

7. The method of claim 6 wherein said title includes text, webpage caption, image, or video.

8. The method of claim 6 wherein said communication session is an interactive blog, forum, or chat room.

9. The method of claim 1 wherein said communication session is linked to a certain part, article, paragraph, image, or video of said webpage by highlighting said certain part, said article, said paragraph, said image, or said video.

10. The method of claim 1 wherein said communication session is linked to a certain part, article, paragraph, image, or video of said webpage by drawing an arrow connecting between said communication session and said certain part, said article, said paragraph, said image, or said video.

11. A method for browsing files of a desktop application using communication sessions wherein said method comprising of;
associating said desktop application with a communication session correlated with a file, and title;
displaying said title when opening said desktop application; and
opening said communication session and said file once said title is selected.

12. The method of claim 10 wherein said title includes text, information, image, or video.

13. The method of claim 10 wherein said communication session is an interactive blog, forum, or chat room.

14. The method of claim 1 wherein said communication session is linked to a certain part of said file by highlighting said certain part.

15. The method of claim 1 wherein said communication session is linked to a certain part of said file by drawing an arrow connecting between said communication session and said certain part.

16. The method of claim 7 wherein said desktop application is a cloud application.
